(19) United States
(12) Patent Application Publication
(10) Pub. No.: US 2014/0052535 A1
(43) Pub. Date: Feb. 20, 2014

(54) WIRED/WIRELESS INTERNET IP SHARING DEVICE FOR CONTROLLING NETWORK ACCESS AND METHOD OF PROVIDING ADVERTISEMENT USING THE SAME

(71) Applicants: MINIGATE. CO. LTD., Seoul (KR); HANWHA SOLUTION & CONSULTING CO., LTD, Seoul (KR)

(72) Inventors: Chang Hoon JUNG, Suwon-si (KR); Heung Soon Park, Namyangju-si (KR)

(73) Assignees: HANWHA SOLUTION & CONSULTING CO., LTD, Seoul (KR); MINIGATE. CO. LTD., Seoul (KR)

(21) Appl. No.: 13/659,842

(22) Filed: Oct. 24, 2012

(30) Foreign Application Priority Data
Aug. 16, 2012 (KR) 10-2012-0089562

(51) Int. Cl. G06Q 30/02

(52) U.S. Cl. 705/14.58; 705/14.73

(57) ABSTRACT

A wired/wireless Internet IP sharing device for controlling network access and a method of providing an advertisement using the same are disclosed. The method of providing the advertisement using the Internet internet protocol (IP) sharing device for controlling network access of a terminal may include providing an advertisement comprising at least one of coupon information, discount information, and product information associated with a location in which the internet IP sharing device is installed to the terminal when a network access request is received from the terminal, and allowing the terminal to access a network when the advertisement is run on the terminal, wherein the allowing includes allowing the terminal to access the network unconditionally when at least one action of a user of the terminal among clicking the advertisement, reproducing a video included in the advertisement, and executing a page viewer of the advertisement is recognized.

### CROSS-REFERENCE TO RELATED APPLICATION

This application claims the priority benefit of Korean Patent Application No. 10-2012-0089562, filed on Aug. 16, 2012, in the Korean Intellectual Property Office, the disclosure of which is incorporated herein by reference.

### BACKGROUND

1. Field of the Invention

The present invention relates to a method of enabling access to a wired/wireless Internet internet protocol (IP) sharing device installed in a public place and of providing an advertisement to a user who accesses a network connected to the wired/wireless Internet IP sharing device.

2. Description of the Related Art

Recently, a demand is increasing from users for a mobile Internet service or a broadband wireless local area network (LAN) service enabling data communication via Internet connection and long-distance communications, such as mobile phones.

A wireless LAN is also referred to as wireless-fidelity (Wi-Fi) connection in which a wireless network is used conveniently as in a high-fidelity stereo system and enables access to the Internet via a personal digital assistant (PDA) or a notebook computer within a certain distance from a wireless access point (AP). In recent times, a range of radio waves has increased considerably from 10 meters to about 50 meters to hundreds of meters.

In particular, use of a wireless LAN as a potential open wireless network is rapidly expanded with wide use of terminals, and Wi-Fi connections are installed in public areas, for example, schools, airports and hotels, to provide high-speed data services to the entire city.

Currently, communications service providers build free Wi-Fi zones for their customers in public places to provide smooth communication through wireless communications networks, and Wi-Fi established by the communications service providers is not aimed at gaining profits, but rather to increase a network speed and to reduce a load in a 3^{rd} generation (3G) network. Further, there is a growing trend towards establishing a wireless AP in a public place, such as a coffee shop, which is not for earning profits, but for providing a service to a customer.

A conventional wireless LAN enables transmission and reception of high-capacity multimedia information at an affordable fee due to enhanced transmission speed but generally restricts use of a wireless AP installed in a public place to a terminal subscribing to a particular communications service provider only. A terminal needs to subscribe to a particular communications service provider so as to utilize the wireless AP installed in the public place, and a terminal determined not to be registered in the communications service provider, via examination as to whether the terminal is autonomously registered, is not allowed to access a network, thus placing limitations on providing of a wireless Internet service.

The present invention suggests a method of enabling use of a wired/wireless Internet IP sharing device installed in a public place and providing an advertisement to a user accessing a network connected to the wired/wireless internet IP sharing device.

### SUMMARY

An aspect of the present invention provides a wired/wireless Internet internet protocol (IP) sharing device enabling access to a network through the wired/wireless Internet IP sharing device installed in a public place, and a method of providing an advertisement using the same.

Another aspect of the present invention also provides a wired/wireless Internet IP sharing device allowing a user to access the wired/wireless Internet IP sharing device installed in a public place in return for watching an advertisement, and a method of providing an advertisement using the same.

Still another aspect of the present invention also provides a wired/wireless Internet IP sharing device ensuring a profitable business model for an administrator of a public place where the wired/wireless Internet IP sharing device is installed or a person who installs the device, and a method of providing an advertisement using the same.

According to an aspect of the present invention, there is provided an Internet IP sharing device for controlling network access of a terminal, the device including an advertisement providing unit to provide an advertisement provided by an advertising server to the terminal in association with the advertising server when a network access request is received from the terminal, and an access controller to allow the terminal to access a network when the advertisement is run on the terminal, wherein the access controller allows the terminal to access the network unconditionally when at least one behavior of a user of the terminal among clicking the advertisement, reproducing a video included in the advertisement, and running a page viewer of the advertisement is recognized.

The advertising server may provide at least one advertisement associated with a location in which the Internet IP sharing device is installed.

The advertising server may provide an advertisement comprising at least one of coupon information, discount information, and product information associated with a location in which the Internet IP sharing device is installed.

According to an aspect of the present invention, there is provided an Internet IP sharing device for controlling network access of a terminal, the device including a storage unit to store an advertisement comprising at least one of coupon information, discount information, and product information associated with a location in which the Internet IP sharing device is installed, an advertisement providing unit to provide the advertisement stored in the storage unit to the terminal when a network access request is received from the terminal, and an access controller to allow the terminal to access a network when the advertisement is run on the terminal, wherein the access controller allows the terminal to access the network unconditionally when at least one action of a user of the terminal among clicking the advertisement, reproducing a video included in the advertisement, and running a page viewer of the advertisement is recognized.

According to an aspect of the present invention, there is provided a method of providing an advertisement using an Internet IP sharing device for controlling network access of a terminal, the method including providing an advertisement comprising at least one of coupon information, discount information, and product information about a location in which the internet IP sharing device is installed to the terminal when a network access request is received from the terminal, and allowing the terminal to access a network when the advertisement is run on the terminal, wherein the allowing the terminal to access the network allows the terminal to access the network unconditionally when at least one action of a user of the terminal among clicking the advertisement, reproducing a video included in the advertisement, and executing a page viewer of the advertisement is recognized.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a communication system for controlling access to a network connected to an Internet internet protocol (IP) sharing device using an advertisement according to an exemplary embodiment of the present invention;

FIG. 2 is a block diagram illustrating a configuration of an Internet IP sharing device for controlling network access through an advertisement according to an exemplary embodiment of the present invention; and

FIG. 3 is a flowchart illustrating a communication method of controlling access to a network connected to an Internet IP sharing device using an advertisement according to an exemplary embodiment of the present invention.

### DETAILED DESCRIPTION

Hereinafter, exemplary embodiments of the present invention will be described in detail with reference to the accompanying drawings.

The exemplary embodiments may be applied to a network system enabling at least one terminal to access to the Internet at the same time through one shared Internet line.

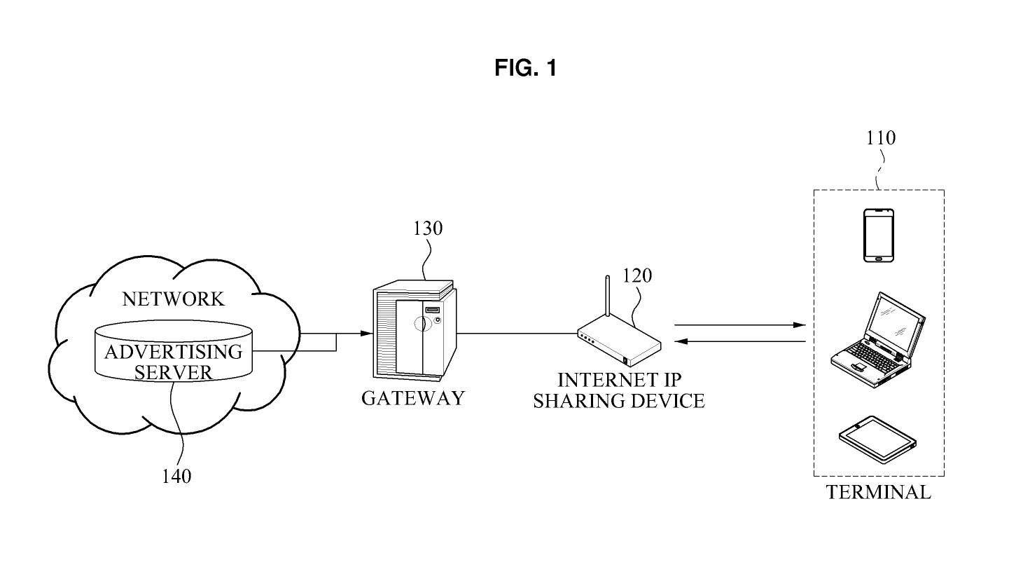

FIG. 1 illustrates a communication system for controlling access to a network connected to an Internet internet protocol (IP) sharing device using an advertisement according to an exemplary embodiment of the present invention. As shown in FIG. 1, the communication system 1 may include an Internet IP sharing device 120, a gateway 130, and an advertising server 140.

The Internet IP sharing device 120 denotes a wired/wireless access point (AP) and controls network access of a plurality of terminals 110. Here, the Internet IP sharing device 120 may be installed in a public place for a plurality of users, for example, a subway station, a school, an airport, a hotel, a coffee shop, and a restaurant. Further, the Internet IP sharing device 120 conforms to not only wire-based local area network (LAN) technologies but also to wireless LAN technologies including a communication method using radio waves and an infrared communication method using light. The wireless LAN technologies cover various standards, wherein the Institute of Electrical and Electronics Engineers (IEEE) 802.11b standard using radio frequency (RF) technology secures an 11 megabits per second (Mbps) transmission rate, but the present invention is not limited to the foregoing communication methods. The terminals 110 may include all communications terminals connectable to the network, such a personal computer (PC), a laptop computer, a tablet PC, and a smart phone.

A user who wants to access the network in a public place in which the Internet IP sharing device 120 is installed may request network access to the Internet IP sharing device 120 in a location using the terminals 110. Here, the Internet IP sharing device 120 identifies the terminals 110 requesting the network access and accesses the advertising server 140 through the gateway 130 to request an advertisement.

The advertising server 140 is a server system which establishes an advertisement database and provides an advertisement to the terminals 110 via the Internet IP sharing device 120 based on the request of the Internet IP sharing device 120. In the present embodiment, the advertising server 140 may extract and provide an advertisement at random or selectively provide a matching advertisement based on the location where the Internet IP sharing device 120 is installed. In particular, when selecting the matching advertisement, the advertising server 140 provides at least one advertisement associated with the location where the Internet IP sharing device 120 is installed, for example, an advertisement including at least one of coupon information, discount information and product information about the location.

Accordingly, the Internet IP sharing device 120 receives an advertisement from the advertising server 140 and transmits the advertisement to the terminals 110, and then allows the terminals 110 to access the network when the advertisement is finally reproduced in the terminals 110. That is, to use the Internet IP sharing device 120 installed in the public place, the user may need to watch the advertisement through the terminals 110 and then utilize the network connected to the Internet IP sharing device 120 in the terminals 110, as necessary.

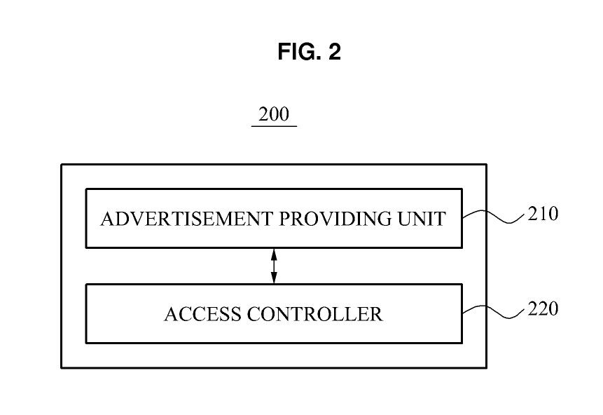

FIG. 2 is a block diagram illustrating a configuration of an Internet IP sharing device for controlling network access through an advertisement according to an exemplary embodiment of the present invention. As shown in FIG. 2, the Internet IP sharing device 200 may include an advertisement providing unit 210 and an access controller 220.

The advertisement providing unit 210 receives an advertisement from an advertising server and to provide the advertisement to a terminal in association with the advertising server when a network access request is received from the terminal. Here, the advertisement provided by the advertising server may include at least one advertisement associated with a location in which the Internet IP sharing device 200 is installed. Furthermore, the advertisement provided by the advertising server is an advertisement to promote the location where the Internet IP sharing device 200 is installed, which may include at least one of coupon information, discount information, and product information.

The access controller 220 controls the network access of the terminal, and allows the terminal to access the network when the advertisement is run on the terminal. That is, when the user performs an action related to viewing the advertisement, for example, clicks the advertisement on the terminal, reproduces a video included in the advertisement, or executes an advertisement page viewer, the access controller 220 may recognize the action and allow the terminal to access the network.

Alternatively, the Internet IP sharing device 200 may further include a storage unit (not shown) inside to store advertisement contents. When the Internet IP sharing device 200 includes the storage unit that is a separate memory space, the advertisement providing unit 210 may read an advertisement stored in the storage unit and transmit the advertisement to the terminal when the terminal requests network access.

Thus, the Internet IP sharing device may use not only an advertisement provided by the advertising server but also an advertisement stored in the internal memory as a medium to allow the terminal to access the network with respect to the network access request of the terminal.

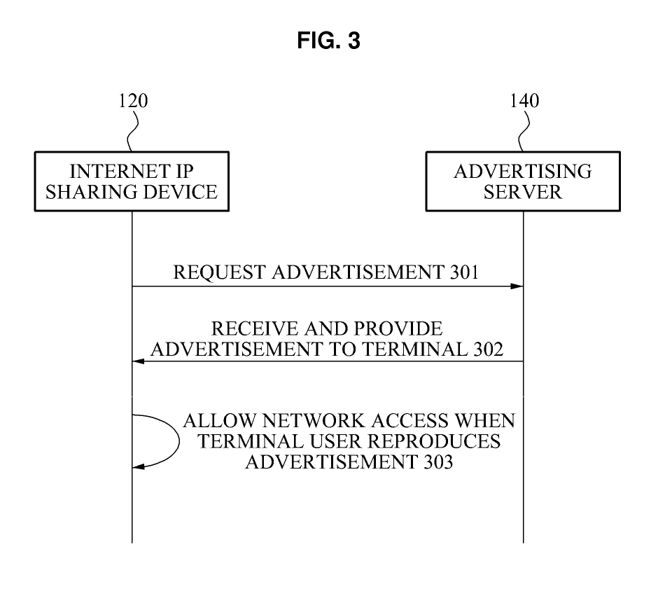

FIG. 3 is a flowchart illustrating a communication method of controlling access to a network connected to an Internet IP sharing device using an advertisement according to an exemplary embodiment of the present invention. The communication method of the present embodiment may be performed by the communication system including the Internet IP sharing device 120 and the advertising server 140 described with reference to FIG. 1.

When a network access request is received from a terminal, the Internet IP sharing device 120 may identify the connected terminal and access the advertising server 140 through the gateway to request an advertisement in operation 310.

Then, the advertising server 140 may select at least one advertisement stored in an advertisement database based on the request of the Internet IP sharing device 120 and provide the advertisement to the terminal via the Internet IP sharing device 120. That is, the Internet IP sharing device 120 may receive the advertisement provided by the advertising server 140 and provide the advertisement to the terminal in operation 302. Here, the advertisement provided by the advertising server 140 may include at least one advertisement associated with a location in which the Internet IP sharing device 120 is installed, which may include at least one of coupon information, discount information, and product information about the location. Further, when a storage medium to store advertisement contents is provided in the Internet IP sharing device 120, the Internet IP sharing device 120 may read an advertisement stored in the storage medium and transmit the advertisement to the terminal based on the network access request of the terminal.

Finally, when the advertisement is reproduced in the terminal, the Internet IP sharing device 120 allows the terminal requesting the network access to access the network in operation 303. That is, when the user of the terminal watches the advertisement through the terminal, the terminal is allowed to access the network connected to the Internet IP sharing device 120.

As described above, the exemplary embodiments of the present invention may provide an advertisement to users attempting to access an Internet IP sharing device installed in a public place and allow any user who watches the advertisement to use the Internet through the Internet IP sharing device. Moreover, the exemplary embodiments of the present invention may realize a business model in which a portion of profits produced from advertisements provided while controlling network access is distributed to business owners in the public place where the internet IP sharing device is installed. In addition, when a customer visiting a shop in a shopping mall where an Internet IP sharing device is installed attempts to access the Internet IP sharing device, the shopping mall transmits an advertisement including various coupons or discount information about the shopping mall or new menus to the customer, inducing the customer to make a spontaneous purchase while allowing the customer to use the Internet through the Internet IP sharing device.

The exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. The aforementioned file systems may be recorded in computer-readable media.

According to exemplary embodiments of the present invention, network access through a wired/wireless Internet IP sharing device installed in a public place is controlled using an advertisement, and thus network access may be open to any user who watches the advertisement and any user may access the Internet IP sharing device installed in the public place to use the Internet for free in return for watching the advertisement.

According to exemplary embodiments of the present invention, an advertisement is provided to a user desiring access to a network through a wired/wireless Internet IP sharing device installed in a public place, and profits from the advertisement are provided to a business owner in the public place who installed the wired/wireless Internet IP sharing device, for example, an administrator or an installer, thus offering a profitable business model to the business owner and increasing profitability and utility of the wired/wireless Internet IP sharing device.

According to exemplary embodiments of the present invention, an advertisement associated with a shopping mall in which a wired/wireless Internet IP sharing device is established is provided to transmit relevant information to customers of a shop and lead to direct sales, thus enhancing utility of the Internet IP sharing device and increasing a request for installation of the sharing device.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An Internet internet protocol (IP) sharing device for controlling network access of a terminal, the device comprising:
an advertisement providing unit to provide an advertisement from an advertising server to the terminal associated with the advertising server when a network access request is received from the terminal; and
an access controller to allow the terminal to access a network when the advertisement is run on the terminal,
wherein the access controller allows the terminal to access the network unconditionally when at least one action of a user of the terminal among clicking the advertisement, reproducing a video included in the advertisement, and running a page viewer of the advertisement is recognized.

2. The device of claim 1, wherein the advertising server provides at least one advertisement associated with a location in which the Internet IP sharing device is installed.

3. The device of claim 1, wherein the advertising server provides an advertisement comprising at least one of coupon information, discount information, and product information associated with a location in which the Internet IP sharing device is installed.

4. An Internet internet protocol (IP) sharing device for controlling network access of a terminal, the device comprising:
a storage unit to store an advertisement comprising at least one of coupon information, discount information, and product information associated with a location in which the Internet IP sharing device is installed;
an advertisement providing unit to provide the advertisement stored in the storage unit to the terminal when a network access request is received from the terminal; and
an access controller to allow the terminal to access a network when the advertisement is run on the terminal,
wherein the access controller allows the terminal to access the network unconditionally when at least one action of a user of the terminal among clicking the advertisement, reproducing a video included in the advertisement, and running a page viewer of the advertisement is recognized.

5. A method of providing an advertisement using an Internet internet protocol (IP) sharing device controlling network access of a terminal, the method comprising:
providing an advertisement comprising at least one of coupon information, discount information, and product information about a location in which the internet IP sharing device is installed to the terminal when a network access request is received from the terminal; and
allowing the terminal to access a network when the advertisement is run on the terminal,
wherein the allowing comprises allowing the terminal to access the network unconditionally when at least one action of a user of the terminal among clicking the advertisement, reproducing a video included in the advertisement, and executing a page viewer of the advertisement is recognized.
